(19) United States
(12) Patent Application Publication
(10) Pub. No.: US 2004/0015988 A1
(43) Pub. Date: Jan. 22, 2004

(54) Visual medium storage apparatus and method for using the same

(76) Inventor: Buvana Venkataraman, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/200,694

(22) Filed: Jul. 22, 2002

(51) Int. Cl. G06F 3/00

(52) U.S. Cl. 725/38

(57) ABSTRACT

A method and system for storing digital data includes receiving a stream of data to be displayed on a visual medium wherein the visual medium further has a digital storage area, intercepting information from the stream of data and storing the information intercepted from the stream of data on the visual medium using the digital storage area. Retrieving digital data includes receiving a visual medium displaying visual information and having digital information stored in a digital storage area associated with the visual medium, accessing the digital information from the digital storage area of the visual medium and presenting the digital information using a combination of multimedia formats and multimedia player devices.

### BACKGROUND OF THE INVENTION

Aspects of the present invention involve the processing of print and display-formatted information. Despite the decreased cost of storage, printing and generating visual content remains a popular form of communicating information and ideas. Generally, people create content using text and images on a computer-like device and send the information as a stream of information for printing on a printer or for display on a display device like a computer monitor or television. This stream of information is often digital but can also be sent in an analog format depending on the specific systems involved. Drivers for these printers and display devices process the stream of information into a suitable format for display on the screen or printing on a printer device. In the case of a printer, the information is printed on paper, slide materials, or other visual mediums for viewing at a later time.

People must read or view the print and display-formatted information to receive the intended message or to appreciate the visual information. Naturally, this requires taking the time to see the text and images on the paper or other visual medium. This is generally not a problem for people who have time to read the material and have adequate eyesight for viewing the information. Moreover, literate people who read regularly and are capable of understanding printed materials continue to be comfortable with and may even prefer printed text and other written documents.

Unfortunately, people with impaired vision or little time to read documents have few options when information is provided in the various print or display formatted mediums. These individuals would rather convert the information back to a digital format for listening or other communication modalities.

Currently, scanner devices that convert printed information to digital data using optical character recognition (OCR) are not an acceptable solution as they can be inaccurate and difficult to use. These scanner devices also require operation by a person with adequate skill, eyesight, knowledge of the scanned content, and time. Even if people with impaired eyesight had the time, they may be unable to operate a scanner for themselves or similarly situated individuals. Similarly, executives and others with demanding schedules cannot take the time to operate the scanner and OCR devices or to carefully review the actual printed documents or to display formatted information. Accordingly, communicating printed or display formatted information to people who cannot or do not want to read or view this type of information remains a challenging problem in communication.

### BRIEF DESCRIPTION OF THE DRAWINGS

FIG. 1 is a block diagram illustrating an overall method and system for processing a visual medium equipped with digital storage in accordance with one implementation of the present invention;

FIG. 2 provides several implementations of the present invention for attaching or embedding a digital storage area in a visual medium;

FIG. 3 is a flowchart diagram of the operations used by visual medium and digital storage (VMDS) writer in accordance with one implementation of the present invention;

FIG. 4 is a flowchart diagram of the operations associated with processing a visual medium and accessing the information stored in digital storage area in accordance with one implementation of the present invention;

FIG. 5 is a block diagram illustrating a visual medium and a VMDS device for either reading or writing information in accordance with one implementation of the present invention; and

FIG. 6 is a block diagram of a VMDS device capable of either reading or writing data to visual medium and suitable for implementing or performing the apparatus or methods in accordance with one implementation of the invention.

### DETAILED DESCRIPTION

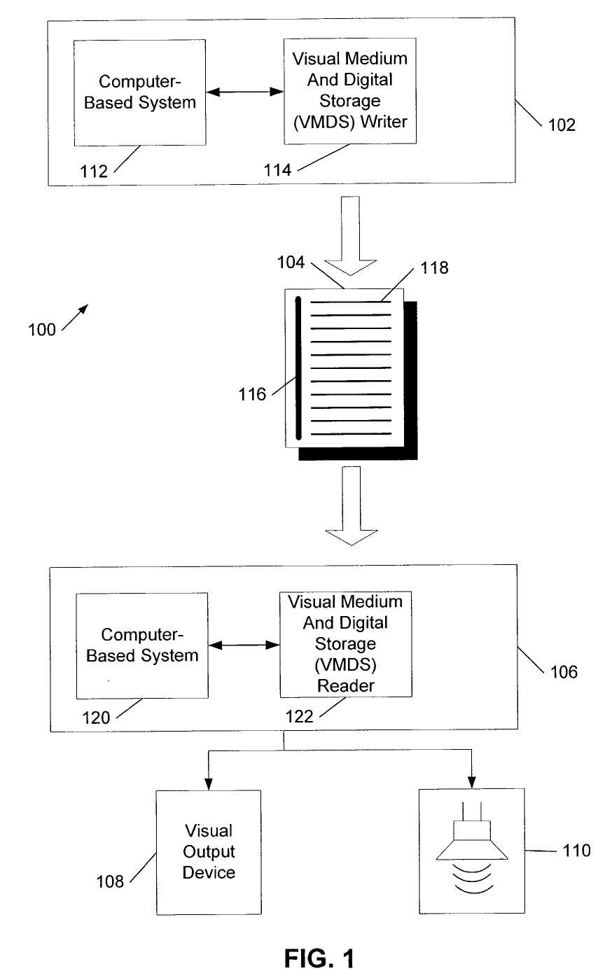

FIG. 1 is a block diagram illustrating an overall method and system for processing a visual medium 104 equipped with a digital storage area 116 in accordance with one implementation of the present invention. Components involved with processing visual medium 104 and digital storage area 116 include a visual medium recording device 102, a visual medium playback device 106, a visual output device 108 and audio speakers 110 for generating sound. For example, the sound generated can include music in addition to speech. Generally, visual medium recording device 102 and visual medium playback device 106 are separate systems designed to work together in accordance with aspects of the present invention.

In one implementation, visual medium recording device 102 includes a computer-based system 112 coupled to a visual medium and digital storage (VMDS) writer, hereinafter referred to as VMDS writer 114. Computer-based system 112 can be a personal computer coupled over a network or bus to VMDS writer 114 or alternatively can be embedded along with VMDS writer 114 in visual medium recording device 102.

In the personal computer configuration, computer-based system 112 generates and transfers visual information having text and images to VMDS writer 114 over a network or bus. Computer-based system 112 also creates and transfers audio information to VMDS writer 114 over the network or bus to be stored on digital storage area 116 associated with visual medium 104. Alternatively, computer-based system 112 can be implemented as an embedded processor according to another implementation of the present invention that transfers text, image, and audio information directly to VMDS writer 114 using on-chip or using board-level communication.

In one implementation, visual medium recording device 102 is a printer device that prints the text and image information as visible information 118 on visual medium 104 as depicted in FIG. 1. Visual medium recording device 102, being a printer in this example, also stores digitized information in digital storage area 116 generally as either text information or voice synthesized versions of the text information corresponding to visible information 118. This digital information is generally stored in digital storage area 116 on or about the same time interval that visible information 118 is placed on the surface of visual medium 104.

Visual medium playback device 106 receives visual medium 104 containing both visual information 118 and the digital information stored in digital storage area 116. In one implementation, visual medium playback device 106 also includes a computer-based system 120 coupled to a visual medium and digital storage (VMDS) reader component 122, hereinafter referred to as VMDS reader 122. Like computer-based system 112 described previously, computer-based system 120 can be integrated with VMDS reader 122 as a personal computer communicating through network connections and buses or as an embedded device communicating directly to VMDS reader 122.

Computer-based system 120 interacts with VMDS reader 122 causing the reader to access and process digital information stored in digital storage area 116 of visual medium 104. In FIG. 1, VMDS reader 122 sends digital audio information to speaker 110 and digital image or video information to visual output device 108. Digital audio information can be stored as synthesized speech in digital storage area 116 or stored in a text format in digital storage area 116 and converted in real-time into synthesized speech by VMDS reader 122; the latter approach reducing storage requirements on digital storage area 116 and increasing the processing requirements on VMDS reader 122.

For example, a paper material enhanced in accordance with the present invention having both text printed on the paper and digital storage area 116 embedded therein can operate as visual medium 104. VMDS reader 122 processes this paper accessing synthesized speech or text corresponding to the information printed on the paper. Visual medium playback device 106 uses computer-based system 120 and VMDS reader 122 to send the synthesized speech to speaker 110 and present the visual information printed on the paper to the visual output device 108. If there is sufficient storage in digital storage area 116, a digital representation of the visual information printed on the paper material is also stored in digital storage area 116. In an alternate implementation, visual medium playback device 106 can selectively present synthesized speech to speaker 110 or present the visual information on visual output device 108 or provide both types of media simultaneously. This system facilitates either listening to the content of a document by way of digital information stored in digital storage area 116 or by way of actually viewing the document through visual output device 108.

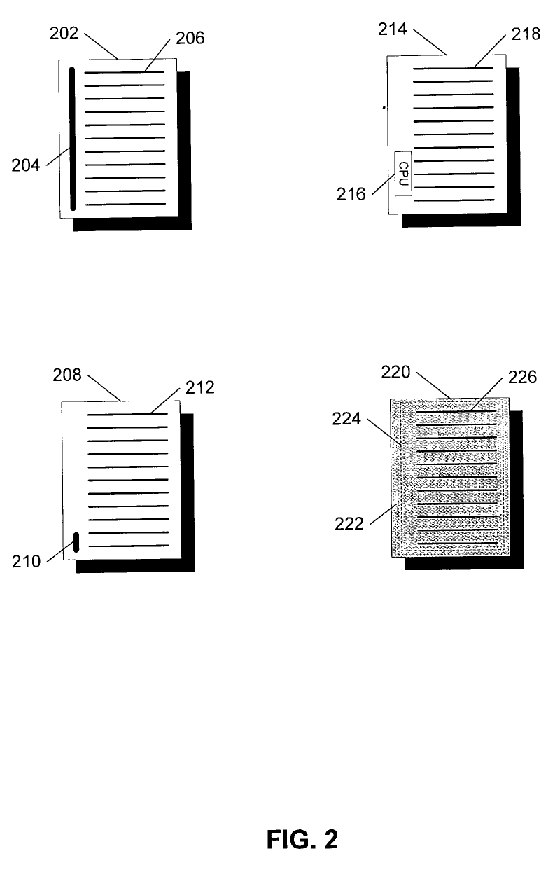

FIG. 2 provides several implementations of the present invention for attaching or embedding a digital storage area in a visual medium. Each of these configurations can be implemented using paper materials, transparent materials used for creating slides, or any other material capable of receiving printed information and a digital storage area in accordance with implementations of the present invention. Storage technologies for storing information in the various digital storage areas described herein may involve magnetic storage, optical storage, solid-state storage and combinations thereof. These technologies can be applied using laser printing, ink jet, and other printing methods capable of delivering the materials used for generating and configuring the digital storage areas described herein. For example, magnetic toner particles can be delivered and attached to paper using laser printing technologies or ink jet technologies. Similarly, toner particles with specific reflective and refractive characteristics can be delivered through one of several printing methods and also have the ability to store information using optical storage techniques.

In one example, visual medium 202 is a material having digital storage area 204 and visual information 206. Visual medium 202 receives visual information 206 as represented by the horizontal lines. These horizontal lines represent text, images, and other visual data without limitation to any specific orientation or direction on visual medium 202. In this example, digital storage area 204 runs lengthwise along the edge of visual medium 202 and is capable of storing audio, video, images and other multimedia information along this corresponding dimension. Alternatively, digital storage area 204 could also run along the width of visual medium 202 and be used in a similar manner (not shown). Both of these arrangements are advantageous in that VMDS writer 114 and VMDS reader 122 can access digital storage area 204 while also scanning over visual medium 202 during write and read operations in portrait and landscape modes.

In another example in FIG. 2, visual medium 208 is a material having digital storage area 210 and visual information 212. Visual medium 208 also displays visual information 212 as represented by the horizontal lines. Similarly, these horizontal lines represent text, images, and other visual data and are not limited to text or other information printed in any specific orientation or direction on visual medium 202. In this implementation, digital storage area 210 is located in a corner or limited area on visual medium 202 and is also capable of storing audio, video, images, and other multimedia information. Instead of running along the edges or length of visual medium 208, digital storage area 210 occupies a less obtrusive portion of visual medium 208 and is limited to this area. Alternatively, digital storage area 210 could also appear in any other area of visual medium 202 and is not just limited to the borders, corners or edges of visual medium 208.

Referring to FIG. 2, yet another implementation uses a visual medium 214 having a central processing unit (CPU) 216, hereinafter processor 216, and visual information 218 as illustrated. As described above, visual medium 214 includes visual information 218 depicted as horizontal lines representing text, images, and other visual data and not limited to text or other information printed in any specific orientation or direction on visual medium 214. In contrast to the other implementations described previously, processor 216 has a digital storage area integrated into on-board or near on-board memory. Processor 216 and the digital storage area can be constructed using flexible integrated circuit technology fabricated at ultra-low temperatures using plastics and other materials. The flexible integrated circuit technology can be developed and subsequently embedded into visual medium 214 or fabricated into visual medium 214 as part of the manufacturing process for visual medium 214.

Because processor 216 accompanies the digital storage area, more processing tasks can be offloaded and solved directly using compute resources associated with visual medium 214. These tasks could include performing speech synthesis or enhancement as well as various image processing enhancement routines. Processor 216 and the digital storage area associated with the processor are located on visual medium 214 such that using visual medium 214 is more cost effective to fabricate or easier to implement. For example, processor 216 and corresponding digital storage area can be placed in an area that a printer device would not access or need to print information.

Visual medium 220 represents yet another example of storing digital information on a visual medium in accordance with implementations of the present invention. In this example, digital storage area 222 is distributed throughout visual medium 220 allowing information storage to be made throughout visual medium 220 only limited, if at all, by boundary 224. Boundary 224 provides a practical limit and standard area coverage by digital storage area 222 to promote interoperability between VMDS reader and VMDS writer devices. Moreover, this arrangement facilitates VMDS writer 114 and VMDS reader 122 access to multiple areas of digital storage area 222 while also scanning over visual medium 220 during write and read operations.

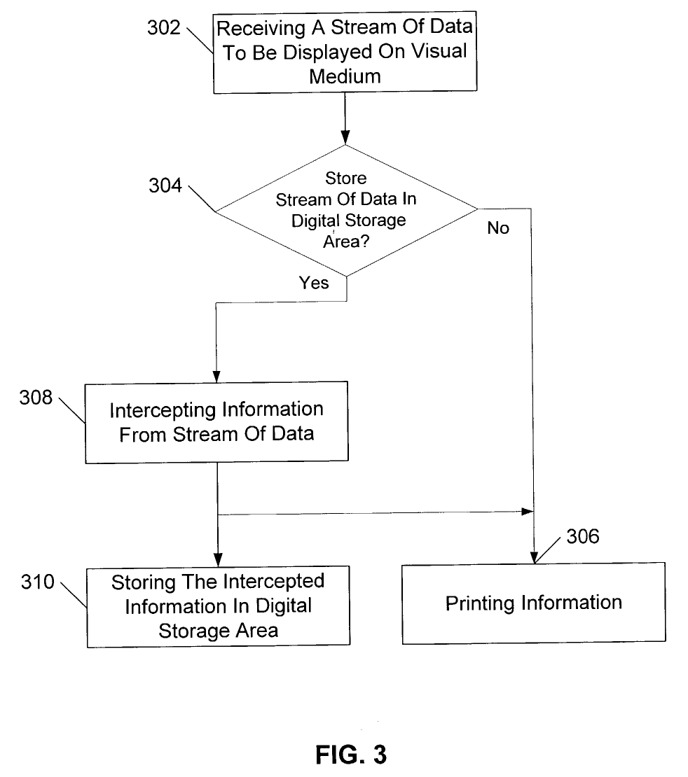

FIG. 3 is a flowchart diagram of the operations used by a VMDS writer in accordance with one implementation of the present invention. Initially, VMDS writer receives a stream of data to be displayed on a visual medium (302). Computer-based system accesses a data file to generate the stream of data or may request that an existing stream of data is passed to the visual medium through the VMDS writer. In one implementation, the computer-based system receives e-mail or other text information for printing on paper or other visual mediums. Alternatively, the computer-based system can be a multi-media device having text, image, and video inputs from networks, other storage areas, television tuners and in some implementations a personal video receiver (PVR) that receives streams of data and stores the streams temporarily on a local hard disk. Closed-captioned text transmitted along with television signals can be conveniently included as part of the stream of information and used as text accompanying image information.

When the computer-based system requests “printing” a file with text and/or images, the VMDS writer transfers the information to the visual medium. Software associated with the VMDS writer may be set to determine whether the stream of data associated with printing the file should also be stored in storage area 116 associated with the visual medium (304). In one implementation, a device driver is set with the option to store information in the digital storage area including sub-option settings to store text, images and/or voice synthesized information associated with the file being printed. Alternatively, an application being used to print the file can query the user to determine if the information should be stored in the digital storage area. The file is printed immediately without storing the information if the option setting or query response indicates that the digital information is not to be stored in the digital storage area (306).

Alternatively, the relevant information is intercepted from the stream of data if the option setting or query response indicates that the information associated with the file being printed is to be stored in the digital storage area (308). Intercepting this information may include analyzing the stream of data for certain tags or blocks of information and buffering the information in temporary storage areas to accommodate for the different input-output rates of the digital storage area compared with generating a visual image on the visual medium through a printing process. The intercepted information may include text converted from text to speech using speech synthesis techniques; compressed and encrypted versions of text and/or synthesized speech enhanced for increased storage efficiency, privacy and playback accuracy; as well as closed-caption text information from television transmissions.

The intercepted information gathered from the stream of data is then stored in the digital storage area associated with the visual medium (310). Storing the intercepted information can be done substantially concurrently as information is printed on the visual medium (306) or can be done during a separate time interval depending on the location of a particular digital storage area and the type of visual medium being used. For example, the visual medium in FIG. 2 can be printed on by a printer device and at a subsequent time interval receive information for storage in digital storage area 210. In part, this is because the digital storage area 210 is not coincident with the printed information 212 on visual medium 208. Conversely, visual medium 220 may receive print information and information for storage in digital storage area 222 in parallel rather than sequentially as the storage area is essentially coincident with the areas on the visual medium being printed upon.

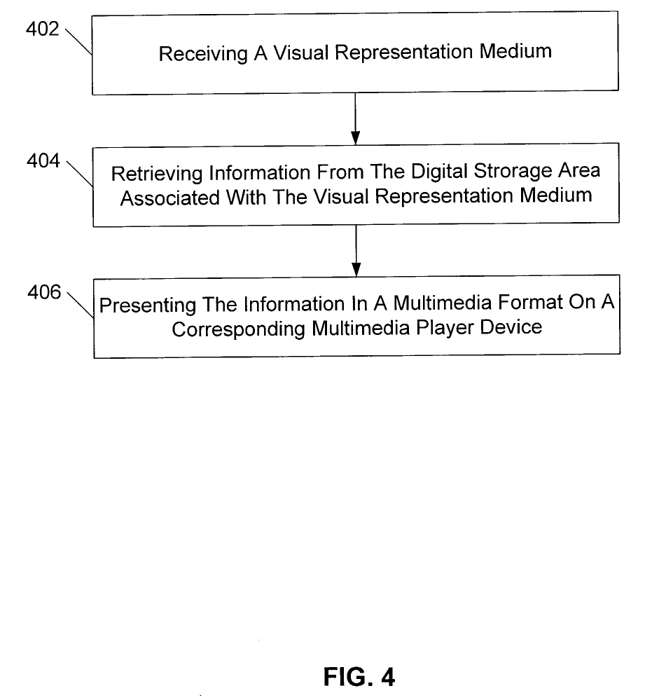

FIG. 4 is a flowchart diagram of the operations associated with processing the visual medium and accessing the information stored in the digital storage area. As described above, the visual medium can be made from various materials including paper and plastic materials capable of being printed on. Generally, the digital storage area is embedded in some portion of the visual medium. Accordingly, while reference can be made to visual medium 104 in FIG. 1, many different types of visual mediums, including those described in conjunction with FIG. 2, can also be used.

Initially, the visual medium playback device receives a visual medium for processing (402). The visual medium generally includes information stored in the digital storage area. This information can be stored with a particular format and header information for ready identification by the VMDS reader. Information in digital storage area 116 may correspond to printed information on a transparent slide, paper or other material. The digital storage area generally contains information derived directly from information printed on the visual medium yet it need not be an identical representation thereof. For example, the digital storage area may contain synthesized speech versions of text on the visual medium yet may not include images or text information in the caption area of the images providing additional information on the images.

The visual medium playback device retrieves information from the digital storage area (404). Depending on how the information was stored, the visual medium playback device directs the VMDS reader to access and retrieve information from the digital storage area in the proper manner. The VMDS reader applies certain cryptographic, compression and data enhancement routines as they are needed. For example, information stored in the digital storage area can be accessed and retrieved by applying data decompression and decryption routines. Text information retrieved from the digital storage area also may be converted to speech using speech synthesis routines.

Once the information is accessed, the visual medium playback device presents the information (406). A device driver or application in the digital storage area readies the information for presentation on a corresponding multimedia player device by processing information in advance. For example, voice synthesized speech can be generated from text and prepared for playback over speakers connected to the visual medium playback device.

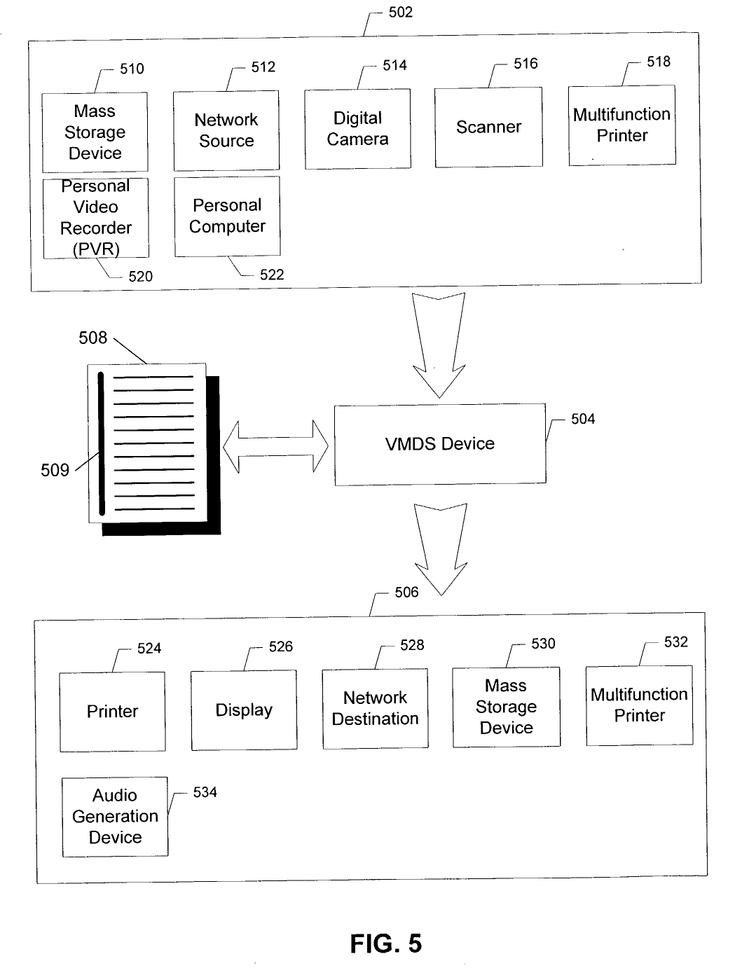

FIG. 5 is a block diagram illustrating a VMDS device 504 capable of either writing information from input devices 502 to visual medium 508 or, alternatively, reading information from visual medium 508 and providing the output of information to output devices 506. VMDS device 504 can be embedded as part of one or more input devices 502 or output devices 506. Instead of being embedded, VMDS device 504 can receive information from input devices 502 or output devices 506 over a bus or other connection device.

In this example, input devices 502 include mass storage device 510, network source 512, digital camera 514, scanner 516, multifunction printer 518, personal video receiver (PVR) 520 and personal computer 522. Output devices 506 in this example include printer 524, display 526, network destination 528, mass storage device 530, multifunction printer 532 and audio generation device 534. VMDS device 504 can be single device capable of reading or writing data or two separate devices for reading and writing.

In operation, incoming streams of information from input devices 502 pass through VMDS device 504 and are written to digital storage area 509 on visual medium 508. In one implementation, incoming stream of data is also printed on visual medium 508 using a printer-type device.

Generally, visual medium is lightweight, portable and easily transported by a user. For example, visual medium 508 can be a paper document having digital storage area 509 embedded thereon. Visual medium 508 and digital information stored on digital storage area 509 is accessed and read by VMDS device 504. The information read by VMDS device 504 from visual medium 508 is forwarded to one or more output devices 506. For example, text information stored in digital storage area 509 can be displayed for viewing on display 526 while a speech synthesized version of the text information is played over audio generation device 534.

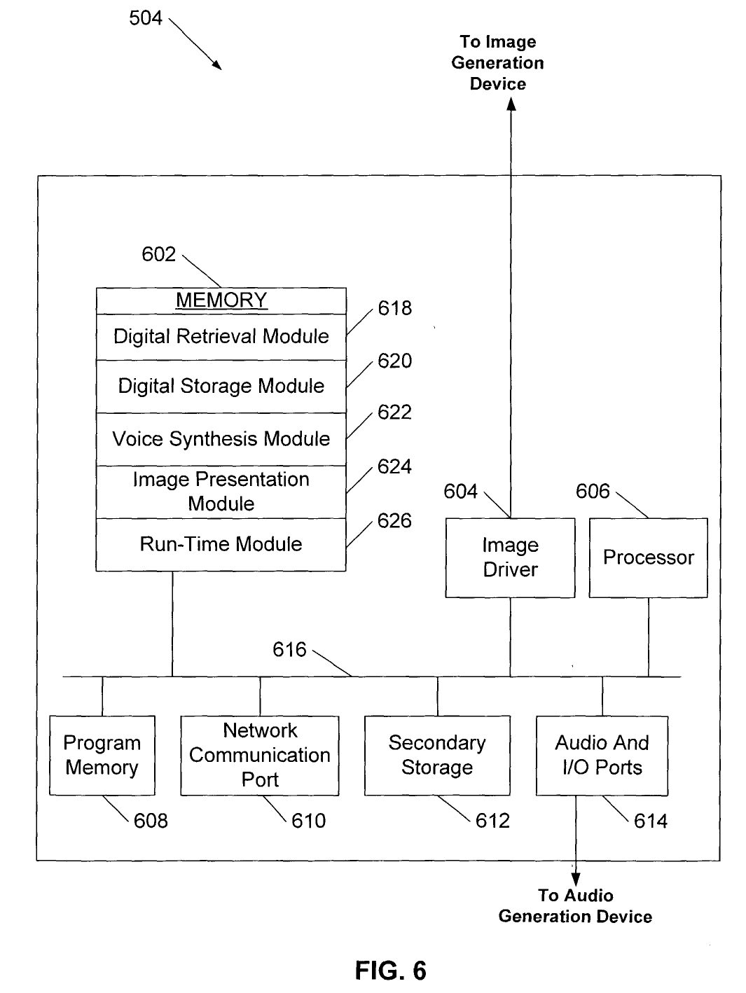

FIG. 6 is a block diagram of one implementation of VMDS device 504 capable of either reading or writing data to a visual medium and suitable for implementing or performing the apparatus or methods consistent with one implementation of the invention. In this example, VMDS device 504 includes a memory 602, typically random access memory (RAM), an image driver 604, a processor 606, a program memory 608 (for example, a writable read-only memory (ROM) such as a flash ROM), a network communication port 610, a secondary storage 612, audio and I/O ports 614 operatively coupled together over bus 616. The system 600 can be preprogrammed, in ROM, for example, or it can be programmed (and reprogrammed) by loading a program from another source (for example, from a floppy disk, a CD-ROM, or another computer).

Image driver 604 provides digital and/or analog signal output to an image generation device such as a display or a printer. In one implementation, the information included on these images and presented on the display or printed on paper, slides or other visual mediums may include text, in addition to other categories of information.

Secondary storage 612 is suitable for storing executable computer programs, including programs embodying the present invention, and data including buffers and temporary storage space as need to implement aspects of the present invention.

Audio and input/output (I/O) ports 614 are coupled to system 600 through bus 616. Audio ports generate analog and/or digital signals amplified for listening over an audio generation device like a speaker. In one implementation of the present invention, the audio generated corresponds to the text information printed on the paper, slides or other visual mediums described previously.

Input/output ports facilitate the receipt and transmission of data (e.g., text, images, videos, and animations) in analog or digital form over communication links such as a serial link, local area network, wireless link, and parallel link.

These input/output (I/O) ports also facilitate communication with a wide variety of peripheral devices including keyboards, pointing devices (such as mouse, touchpad and touchscreen), and printers. Alternatively, separate connections (separate buses) can be used to interface with these peripheral devices using a combination of Small Computer Systems Interface (SCSI), Universal Serial Bus (USB), IEEE 1394/Firewire, Personal Computer Memory Card International Association (PCMCIA) or any other protocol suitable for interfacing with the peripheral device being attached to system 504.

In general, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, the processor receives instructions and data from a read-only memory and/or a random access memory. Also, a computer will include one or more secondary storage or mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents. CLAIMS

What is claimed is:

1. A method of storing digital data, comprising:
receiving a stream of data to be displayed on a visual medium wherein the visual medium further has a digital storage area;
intercepting information from the stream of data; and
storing the information intercepted from the stream of data on the visual medium using the digital storage area.

2. The method of claim 1 further comprising:
placing a portion of the stream of data onto the visual medium in a visual format.

3. The method of claim 1 wherein the stream of data received is generated by a computer system.

4. The method of claim 1 wherein the stream of data received is generated by a multimedia device.

5. The method of claim 4 wherein the multimedia device includes a television tuner.

6. The method of claim 5 wherein the stream of data includes visual images and closed caption text received from the television tuner.

7. The method of claim 3 wherein the multimedia device is a personal video receiver (PVR) capable of receiving video, images and audio information and storing the various types of information in a storage area associated with the PVR.

8. The method of claim 1 wherein intercepting information further comprises:
identifying text information in the stream of data; and
converting the text information into an audio voice representation of the text information using speech synthesis.

9. The method of claim 8 further comprising compressing the audio voice representation of the text information.

10. The method of claim 1 wherein intercepting information further comprises:
identifying text information in the stream of data; and
compressing the text information in preparation for storage.

11. The method of claim 1 wherein storing the intercepted information comprises writing the intercepted information into the digital storage area using a magnetic field.

12. The method of claim 1 wherein the digital storage area includes a flexible integrated circuit capable of storing digital information.

13. The method of claim 1 wherein the digital storage area is a magnetic material capable of storing digital information in response to a magnetic field.

14. The method of claim 13 wherein the magnetic material is located along one dimension of the visual medium.

15. The method of claim 12 wherein the magnetic material is distributed throughout the visual medium.

16. The method of claim 1 wherein the visual medium is a paper material.

17. The method of claim 16 wherein the paper material is capable of receiving laser toner particles.

18. The method of claim 16 wherein the paper material is capable of receiving ink from an ink jet.

19. The method of claim 1 wherein the visual medium is a transparent material used for presenting overhead slide presentations.

20. A method of retrieving digital data, comprising:
receiving a visual medium displaying visual information and having digital information stored in a digital storage area associated with the visual medium;
accessing the digital information from the digital storage area of the visual medium; and
presenting the digital information in one or more multimedia formats on one or more corresponding multimedia player devices.

21. The method of claim 20 further comprising converting the digital portion into one or more multimedia formats.

22. The method of claim 21 wherein the converting includes performing text-to-speech voice synthesis.

23. The method of claim 21 wherein the converting includes generating music from the digital portion.

24. The method of claim 21 wherein the converting includes generating digital images from the digital portion.

25. The method of claim 20 wherein the visual medium includes a paper material having visual information printed thereon and the digital storage area embedded in the paper material.

26. The method of claim 20 wherein receiving the visual medium further includes receiving a transparent slide material having visual information printed thereon and the digital storage area embedded in the transparent slide material.

27. The method of claim 20 wherein the retrieving further comprises:
accessing the digital storage area of the visual medium using a magnetic sensor device.

28. The method of claim 20 wherein the retrieving further comprises:
accessing the digital storage area of the medium through a flexible integrated circuit embedded in the visual medium.

29. The method of claim 20 wherein the presenting includes playing a speech synthesized version of the textual information on the visual medium through a speaker system.

30. The method of claim 20 wherein the presenting includes displaying digital images corresponding to the images and text information on the visual medium on a display device.

31. The method of claim 30 wherein the digital images are displayed over a period of time forming a video sequence.

32. A visual medium comprising:
a first material capable of receiving visual information from a printer device; and
a second material embedded in the first material and capable of storing digital information transferred through the printer device.

33. The visual medium of claim 32 wherein the first material includes a paper material.

34. The visual medium of claim 32 wherein the first material includes a transparent material for making slides.

35. The visual medium of claim 32 wherein the second material is configured into a flexible integrated circuit having storage capabilities.

36. The visual medium of claim 32 wherein the second material is a magnetic substance capable of storing digital information.

37. A means for storing digital data, comprising: means for receiving a stream of data to be displayed on a visual medium wherein the visual medium further has a digital storage area;
means for intercepting information from the stream of data; and
means for storing the information intercepted from the stream of data on the visual medium using the digital storage area.

38. A means for retrieving digital data, comprising:
means for receiving a visual medium displaying visual information and having digital information stored in a digital storage area associated with the visual medium;
means for accessing the digital information from the digital storage area of the visual medium; and
means for presenting the digital information in one or more multimedia formats on one or more corresponding multimedia player devices.

39. A computer program product for storing digital data, tangibly stored on a computer-readable medium, comprising instructions operable to cause a programmable processor to:
receive a stream of data to be displayed on a visual medium wherein the visual medium further has a digital storage area;
intercept information from the stream of data; and
store the information intercepted from the stream of data on the visual medium using the digital storage area.

40. A computer program product for retrieving digital data, tangibly stored on a computer-readable medium, comprising instructions operable to cause a programmable processor to:
receive a visual medium displaying visual information and having digital information stored in a digital storage area associated with the visual medium;
access the digital information from the digital storage area of the visual medium; and
present the digital information in one or more multimedia formats on one or more corresponding multimedia player devices.
